(19) United States
(12) Patent Application Publication
(10) Pub. No.: US 2013/0305307 A1
(43) Pub. Date: Nov. 14, 2013

(54) SERVER, ELECTRONIC APPARATUS, SERVER CONTROL METHOD AND COMPUTER-READABLE MEDIUM

(71) Applicant: KABUSHIKI KAISHA TOSHIBA, Tokyo (JP)

(72) Inventor: Kentaro Nagahama, Tachikawa-shi (JP)

(73) Assignee: KABUSHIKI KAISHA TOSHIBA, Tokyo (JP)

(21) Appl. No.: 13/780,400

(22) Filed: Feb. 28, 2013

(30) Foreign Application Priority Data
May 9, 2012 (JP) 2012-108039

(51) Int. Cl. H04N 21/258

(52) U.S. Cl. CPC H04N 21/25808
USPC 725/116

(57) ABSTRACT

According to one embodiment, a server includes a receiver, a setting module and a storage. The receiver is configured to receive history data comprising a history of channel operations for switching programs. The setting module is configured to set a weight for each program based on a history of channel operations according to a first rule. The storage is configured to store the weight set for each program.

### CROSS-REFERENCE TO RELATED APPLICATION(S)

This application is based upon and claims the benefit of priority from Japanese Patent Application No. 2012-108039, filed May 9, 2012; the entire contents of (all of) which are incorporated herein by reference.

### FIELD

Embodiments described herein relate generally to a server, an electronic apparatus, a server control method, and a computer-readable medium.

### BACKGROUND

A technique of accumulating pieces of information of TV programs that have been viewed by a user and estimating the tastes of the user on the basis of the accumulated program viewing history has been disclosed.

However, there may occur a case that a user continues to view programs on the new channel after channel switching. In such a case, pieces of information of second and following programs on the new channel may not be stored as part of a program viewing history. New techniques for estimating the tastes of a user are desired.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 shows a program viewing system which uses a server according to an embodiment.

FIG. 2 shows the configuration of a TV receiver which is used in the program viewing system according to the embodiment.

FIG. 3 shows the configuration of a server which is used in the program viewing system according to the embodiment.

FIG. 4 shows the configuration of a tablet PC which is used in the program viewing system according to the embodiment.

FIG. 5 shows an example flow that a user designates programs and channel switching is made in response in the program viewing system according to the embodiment.

FIG. 6 shows weights that are set for respective viewing programs by the server according to the embodiment based on a history of channel operations of a user according to a first rule.

FIG. 7 shows another example flow that a user designates programs and channel switching is made in response in the program viewing system according to another embodiment.

FIG. 8 shows another set of weights that are set for respective viewing programs by the server according to another embodiment based on a history of channel operations of a user according to a first rule.

FIG. 9 shows a further example flow that a user designates programs and channel switching is made in response in the program viewing system according to another embodiment.

FIG. 10 shows a further set of weights that are set for respective viewing programs by the server according to another embodiment based on a history of channel operations of a user according to a first rule.

FIG. 11 is a flowchart showing how the server according to another embodiment operates.

FIG. 12 shows a program viewing system which uses a server according to a further another embodiment.

### DETAILED DESCRIPTION

According to one embodiment, a server includes a receiver, a setting module and a storage. The receiver is configured to receive history data comprising a history of channel operations for switching programs. The setting module is configured to set a weight for each program based on a history of channel operations according to a first rule. The storage is configured to store the weight set for each program.

Various Embodiments will be described hereinafter with reference to the accompanying drawings.

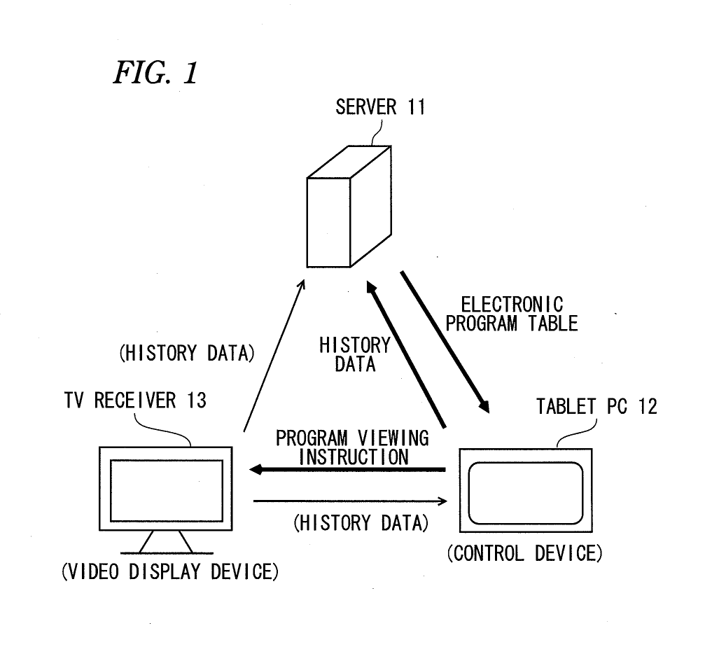

FIG. 1 shows a program viewing system which uses a server according to a first embodiment and relates to viewing of TV programs. An electronic apparatus (TV receiver) 13 receives a broadcast signal of a broadcast program and displays the broadcast program on its video display.

An electronic apparatus (tablet PC) 12 is an electronic terminal which has a network function and is connected to and communicates with a server 11 via a network such as the Internet. In this embodiment, the tablet PC 12 operates as a control device. The tablet PC 12 is connected to and can communicate with the TV receiver 13 via a network function such as Wi-Fi LAN. The tablet PC 12 can be replaced by a smartphone or the like.

As shown in FIG. 1, in this embodiment, the server 11 delivers an electronic program table to the tablet PC 12 (control device). The tablet PC 12 displays the received electronic program table on its display screen in response to a user manipulation, for example. The user can switch to designate a program he or she wants to view from the electronic program table.

In the embodiment, when the user designates a program in the electronic program table, the tablet PC 12 instructs the TV receiver 13 to switch to the designated channel (viewing instruction). Furthermore, the tablet PC 12 communicates user channel switching history data (history data comprising a history of channel operations for switching programs of a user) to the server 11.

The method for communicating channel switching history data to the server 11 is not limited to the above. One alternative is that the TV receiver 13 communicates channel switching history data to the server 11 when receiving a channel switching instruction. Another alternative is that the TV receiver 13 communicates channel switching history data to the tablet PC 12 (control device) and then the tablet PC 12 communicates it to the server 11.

The server 11 according to the embodiment is equipped with a receiver (network communication device 31) for receiving history data comprising a history of channel operations for switching programs, by a user, which is sent from the tablet PC 12, for example.

The server 11 is also equipped with a setting module (user tastes calculating module 32c) for setting a weight for each program based on the history of channel operations of the user according to a first rule, and a storage (user history database 32b) for storing the weight which is set for each program.

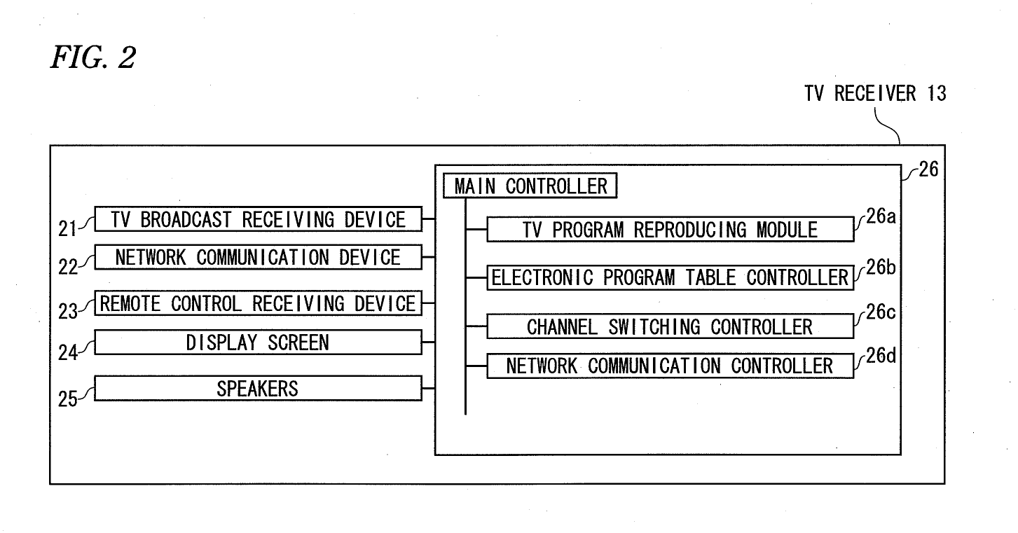

FIG. 2 shows the configuration of the TV receiver 13 which is used in the program viewing system according to the first embodiment. As shown in FIG. 2, the TV receiver 13 is equipped with a TV broadcast receiving device 21 such as a tuner for receiving a broadcast signal of a broadcast program, a network communication device 22 which is connected to the network, a remote control receiving device 23 for receiving a remote control signal that is transmitted from a remote controller (not shown), a display screen 24 on which video of the received broadcast program is displayed, speakers 25 for outputting a sound of the received broadcast program, and a main controller 26 for performing main controls of the TV receiver 13.

For example, the main controller 26 is equipped with a TV program reproducing module 26a, an electronic program table controller 26b, a channel switching controller 26c, and a network communication controller 26d.

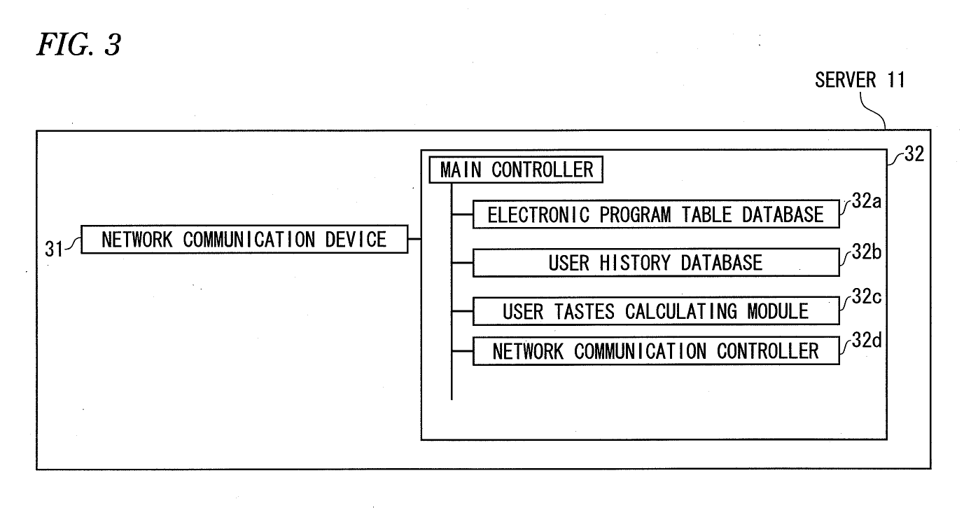

FIG. 3 shows the configuration of the server 11 which is used in the program viewing system according to the first embodiment. As shown in FIG. 3, the server 11 is equipped with a network communication device 31 which is connected to the network and performs a communication, and a main controller 32 for performing main controls of the server 11.

For example, the main controller 32 is equipped with an electronic program table database 32a, a user history database 32b, a user tastes calculating module 32c, and a network communication controller 32d.

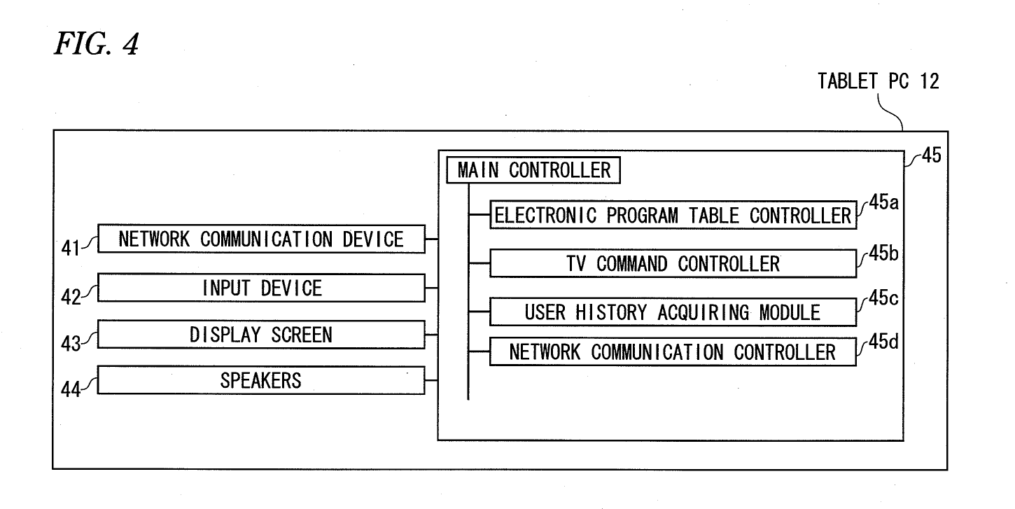

FIG. 4 shows the configuration of the tablet PC 12 which is used in the program viewing system according to the first embodiment. As shown in FIG. 4, the tablet PC 12 is equipped with a network communication device 41 which is connected to the network and performs a communication, an input device such as a touch sensor or a keyboard, a display screen 43 on which video etc. are displayed, speakers 44 for outputting a sound, and a main controller 45 for performing main controls of the tablet PC 12.

For example, the main controller 45 is equipped with an electronic program table controller 45a, a TV command controller 45b, a user tastes acquiring module 45c, and a network communication controller 45d.

As mentioned above, the technique of accumulating pieces of information of TV programs that have been viewed by a user and estimating the tastes of the user on the basis of the accumulated program viewing history is known.

However, in an actual use scene of a user, there may occur a case that a user continues to view programs on the new channel immediately after channel switching. In such a case, pieces of information of second and following programs on the new channel may not be stored as part of a program viewing history.

In view of the above, in this embodiment, for example, if programs are broadcast between two program designating manipulations (two channel operations for switching programs) made by a user by selecting programs using channel buttons or an electronic program table, pieces of information of all the programs that are broadcast between the two program designating manipulations are recorded as history data.

Furthermore, every time a new one of continuous programs beginning from a program designated first (i.e., a program to which switching was made first) is viewed, a weight relating to user tastes is set for the new program and recorded as history data.

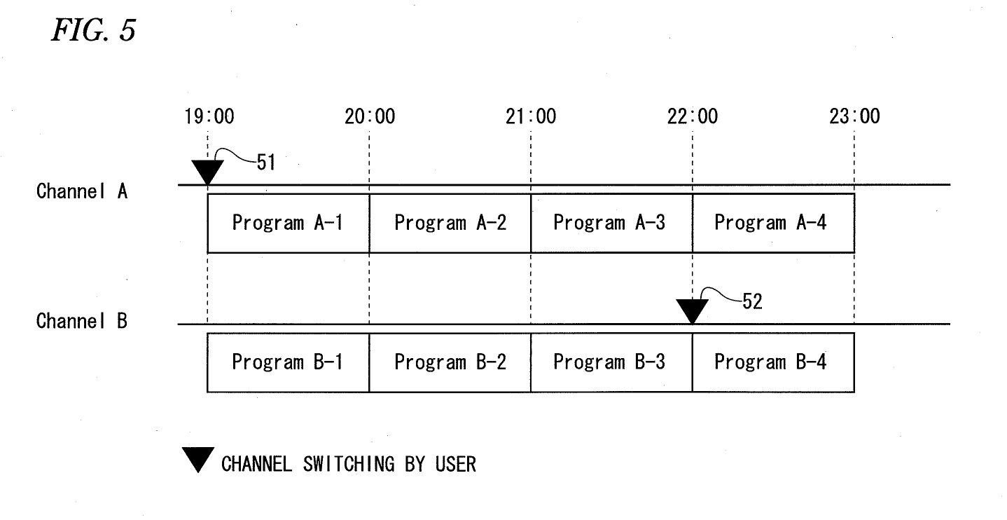

FIG. 5 shows an example flow that a user designates programs and channel switching is made in response in the program viewing system according to the embodiment.

In this example, the server 11 is informed by the TV receiver 13 or the tablet PC 12 (control device) that switching has been made to channel A at 19:00 (indicated by mark 51) and that switching has been made to channel B at 22:00 (indicated by mark 52).

The server 11 stores, in the user history database 32b, pieces of information of “program A-1,” “program A-2,” and “program A-3” that are broadcast on channel A from 19:00 to 22:00 and “program B-4” that is broadcast on channel B from 22:00 as pieces of information of programs (viewing programs) viewed by the user.

Furthermore, in the embodiment, for example, the server 11 sets weights in such a manner that “program A-1” and “program B-4” that are started immediately after actual program designation (channel switching) by the user are given largest weights because the user would be most interested in them, and records the thus-set weights.

For example, the server sets a smaller weight for “program A-2” which is viewed next to “program A-1” and records the thus-set weight. The server sets an even smaller weight for “program A-3” that is viewed next to “program A-2” and records the thus-set weight.

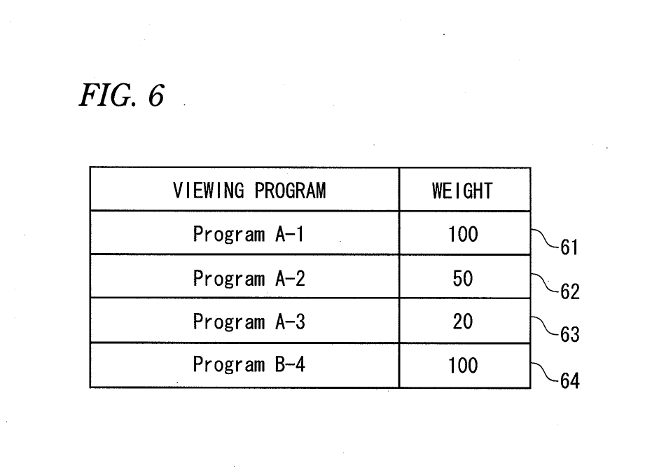

FIG. 6 shows weights that are set for respective viewing programs by the server 11 according to the embodiment on the basis of a user viewing program designation history according to a first rule. More specifically, FIG. 6 shows example weights that are set for the respective viewing programs shown in FIG. 5 and recorded in the user history database 32b by the server 11.

As shown in FIG. 6, a weight “100” is given to “program A-1” and “program B-4” (indicated by numerals 61 and 64, respectively) and recorded because the user would be most interested in them. As indicated by numeral 62, a weight “50” which is smaller than the weight for “program A-1” is given to “program A-2” which is viewed next to “program A-1” and recorded. As indicated by numeral 63, a weight “20” which is smaller than the weight for “program A-2” is given to “program A-3” which is viewed next to “program A-2” and recorded.

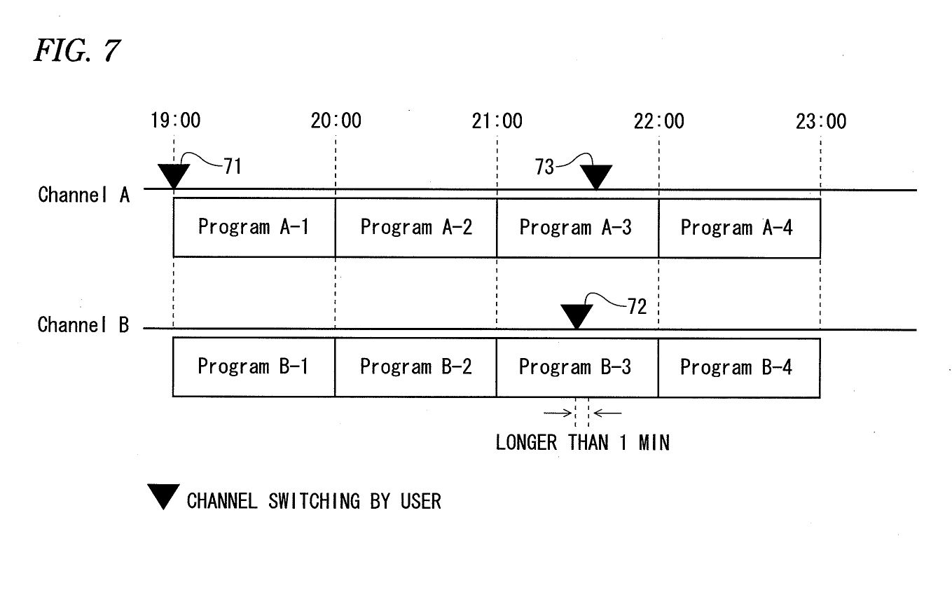

FIG. 7 shows another example flow that a user designates programs and channel switching is made in response in the program viewing system according to the embodiment.

As shown in FIG. 7, this example is such that a user makes switching to another channel (channel B) (indicated by mark 72) in the midst of broadcast of “program A-3” and then makes switching to the original channel to view “program A-3” again (indicated by mark 73).

For example, for discrimination from zapping, weighting processing described above may be performed in the case where the channel B staying time is longer than a predetermined time (e.g., about 1 min).

“Program A-1” and “program A-2” are weighted in the same manners as in the example of FIG. 5. Although switching is made to “program B-3” in the midst of broadcast of “program A-3,” “program A-3” is viewed again. Therefore, “program A-3” is given a large weight because the user would have an intention of viewing it. The weight for “program A-3” may be set variably depending on the viewing time of “program B-3.”

“Program B-3” is given a small weight because switching is made to another program in the midst of its broadcast though it is viewed starting from a midway position. As in the case of “program A-3,” the weight for “program B-3” may be set variably depending on the viewing time of “program B-3.”

Since “program A-4” is viewed next to “program A-4” to which switching is made last, “program A-4” is given the same weight as “program A-2.”

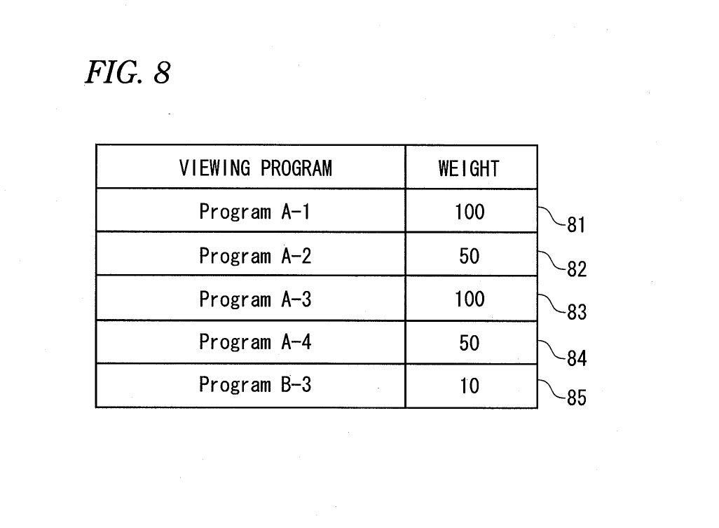

FIG. 8 shows weights that are set for respective viewing programs by the server 11 according to the embodiment on the basis of a user viewing program designation history according to a first rule. More specifically, FIG. 8 shows example weights that are set for the respective viewing programs shown in FIG. 7 and recorded in the user history database 32b by the server 11.

As shown in FIG. 8, “program A-1” and “program A-2” are given the same weights as in the example of FIG. 6, that is, they are given weights “100” and “50,” respectively (indicated by numerals 81 and 82, respectively). The thus-set weights are recoded in the user history database 32b.

Although switching is made to “program B-3” in the midst of broadcast of “program A-3,” “program A-3” is viewed again. Therefore, “program A-3” is given a large weight “100” (indicated by numeral 83) because the user would have an intention of viewing it.

“Program B-3” is given a small weight “10” (indicated by numeral 85) because switching is made to another program in the midst of its broadcast though it is viewed starting from a midway position.

Since “program A-4” is viewed next to “program A-4” to which switching is made last, “program A-4” is given the same weight “50” as “program A-2” (indicated by numeral 84).

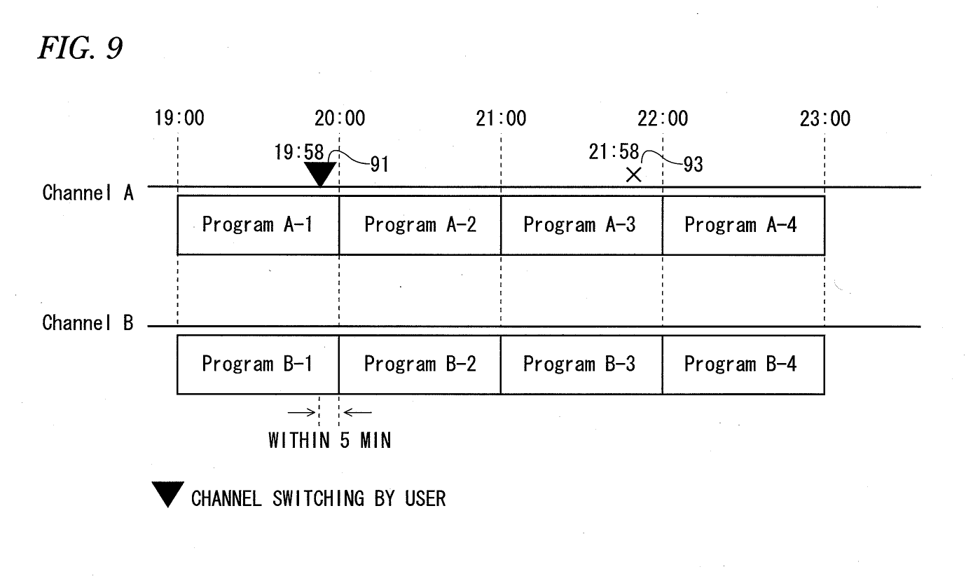

FIG. 9 shows a further example flow that a user designates programs and channel switching is made in response in the program viewing system according to the embodiment.

As shown in FIG. 9, this example is such that a user makes switching to “program A-1” at time 19:58, that is, immediately before the end of its broadcast (indicated by mark 91).

In this case, no history data is stored for “program A-1” with an understanding that the user does not have an intention of viewing it, because switching is made to it immediately before the end of its broadcast though in the midst of its broadcast.

Although “program A-2” is the second program that is viewed after the switching to channel A, “program A-2” is given a large weight with the understanding that the user does not have an intention of viewing “program A-1” and hence “program A-2” is substantially the first viewing program. The thus-set weight is recoded in the user history database 32b.

An instruction to power off the TV receiver 13 at time 21:58 (indicated by mark 93), that is, in the midst of broadcast of “program A-3” is effective. However, time 21:58 is immediately before the end of broadcast of “program A-3,” it is given the same weight as a program that is viewed to the end.

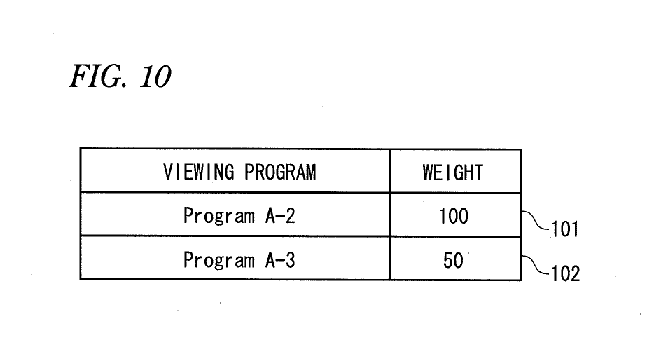

FIG. 10 shows weights that are set for respective viewing programs by the server 11 according to the embodiment on the basis of a user viewing program designation history according to a first rule. More specifically, FIG. 10 shows example weights that are set for the respective viewing programs shown in FIG. 9 and recorded in the user history database 32b by the server 11.

As shown in FIG. 10, “program A-2” is given a large weight “100” (indicated by numeral 101) with the understanding that it is substantially the first viewing program. The thus-set weight is recoded in the user history database 32b.

With the understanding that the enforcement time of the instruction to power off the TV receiver 13 is immediately before the end of broadcast of “program A-3,” it is given a weight “50” that would be given to it if it were viewed to the end (indicated by numeral 102).

The above-mentioned weight values are just example, and different weight values may be used in practice.

According to the embodiment having the above-described features, pieces of information of second and following programs that are viewed by a user on the new channel after channel switching to it by the user can be recorded as history data. If a user keeps the TV receiver 13 powered-on though he or she is not interested in programs that are displayed during that period, weights for those programs can be set small.

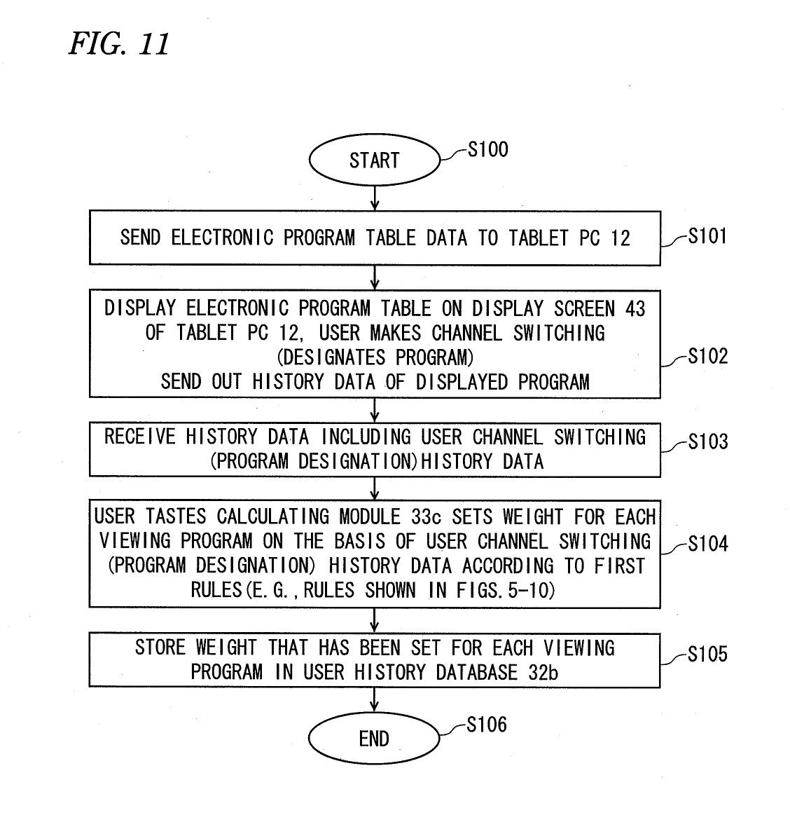

FIG. 11 is a flowchart showing how the server 11 according to the embodiment operates.

The process starts at step S100. At step S101, the server 11 sends electronic program table data to the tablet PC 12. At step S102, an electronic program table is displayed on the display screen of the tablet PC 12. A user makes channel switching (designates a program), and history data of the displayed program is sent out.

At step S103, the server 11 receives the history data which includes user channel switching (program designation) history data.

At step S104, the user tastes calculating module 33c, for example, sets a weight for each viewing program on the basis of user channel switching (program designation) history data according to a first rule (e.g., the rules shown in FIGS. 5-10).

At step S105, the weight that has been set for each viewing program is stored in the user history database 32b. The process is finished at step S106.

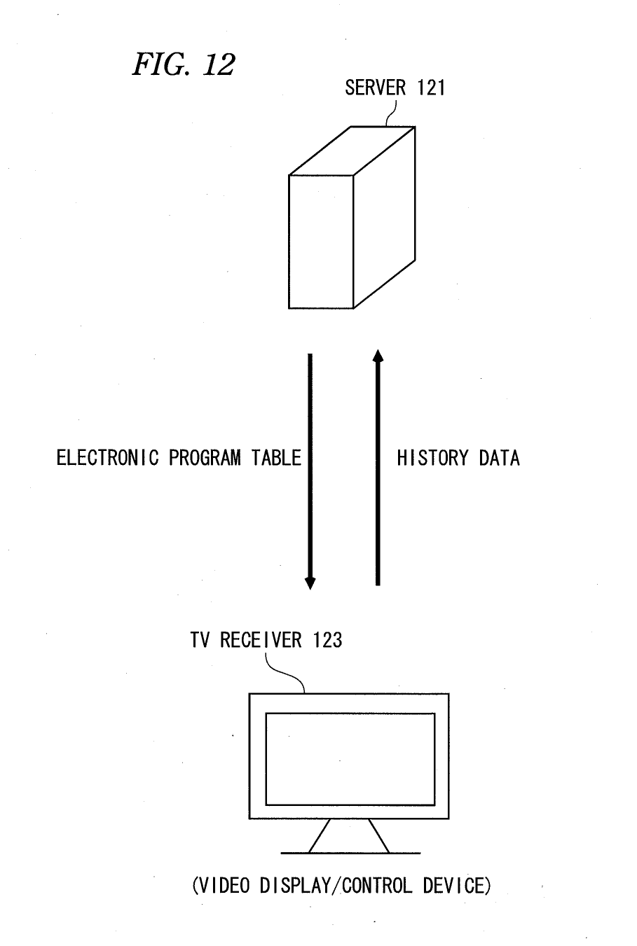

FIG. 12 shows a program viewing system which uses a server 121 according to a second embodiment.

In this embodiment, a TV receiver 123 is a control device and has functions of receiving an electronic program table from the server 121, displaying it, and informing the server 121 that a user has made channel switching by specifying a channel number through a remote controller (not shown) or selecting a channel through the electronic program table.

The server 121 delivers an electronic program table to the TV receiver 123 and records user channel switching history data that, is communicated from the TV receiver 123.

As described above, in the first and second embodiments, the TV receiver 12 or 123 or the tablet PC 12 communicates channel switching (program designation) history data to the server 11 or 121. The server 11 or 121 sets weights for broadcast programs that are broadcast between two program designating manipulations (two channel operations for switching programs) made by a user, and records the thus-set weights in the user history database 32b.

If switching is made to another channel in the midst of viewing of one program, that program is given a small weight. However, if the channel switching is made immediately before the end of the broadcast of that program, the program is given an original weight that would be given to it if it were viewed to the end.

If switching is made to a program immediately before the end of its broadcast, no history data of this program is recorded. Alternatively, history data of this program may be recorded with a small weight. On the other hand, if switching is made from one program to another program in the midst of viewing of the one program but the one program is viewed again later, a large weight is set for the one program with an understanding that the user has an intention of viewing it (see FIGS. 7 and 8).

Not only channel switching timing but also power on/off timing may be used as a factor in determining a weight.

The TV receiver 13 or 123 or the tablet PC 12 may perform processing of setting weights for programs that have been broadcast between two channel switching manipulations and send sets of history data and a weight to the server 11 or 121.

As described above, a server (11, 121) according to each embodiment is equipped with a receiver (network communication device 31) for receiving history data comprising a history of channel operations for switching programs; a setting module (user tastes calculating module 32c) for setting a weight for each program based on the history of channel operations according to a first rule; and a storage (user history database 32b) for storing the weight set for each program.

The first rule comprises a rule that a first program that is viewed immediately after a channel operation for switching programs is set a first weight and a second program that is viewed next to the first program is set a second weight that is smaller than the first weight.

The first rule comprises a rule that a third program that is viewed next to the second program is set a third weight that is smaller than the second weight.

The first rule comprises a rule that if another program is switched to be viewed during viewing of one program and the one program is switched to be viewed within a predetermined time from a switching time of the other program, the one program is set a larger weight that is larger than a weight of the other program.

The channel operations for switching programs use an electronic program table, for example.

As such, each embodiment provides a new technique that makes it possible to estimate user tastes.

All the steps of the control process according to each embodiment can be implemented by software. Therefore, the advantages of each embodiment can easily be obtained merely by installing programs of the control process in ordinary computers via computer-readable storage media that are stored with the programs and running the installed programs.

The invention is not limited to the above embodiments themselves and, in the practice stage, may be embodied in such a manner that constituent elements are modified in various manners without departing from the spirit and scope of the invention. And various inventive concepts may be conceived by properly combining plural constituent elements disclosed in each embodiment. For example, several ones of the constituent elements of each embodiment may be omitted. Furthermore, constituent elements of different embodiments may be combined as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server comprising:
a receiver configured to receive history data comprising a history of channel operations for switching programs;
a setting module configured to set a weight for each program based on a history of channel operations according to a first rule; and
a storage configured to store the weight set for each program.

2. The server of claim 1, wherein the first rule comprises a rule that a first program which is viewed immediately after a channel operation for switching programs is set a first weight and a second program which is viewed next to the first program is set a second weight being smaller than the first weight.

3. The server of claim 2, wherein the first rule comprises a rule that a third program which is viewed next to the second program is set a third weight smaller than the second weight.

4. The server of claim 1, wherein the first rule comprises a rule that, if another program is switched to be viewed during viewing of one program and the one program is switched to be viewed within a predetermined time from a switching time of the other program, the one program is set a larger weight larger than a weight of the other program.

5. The server of claim 1, wherein the channel operations for switching programs use an electronic program table.

6. An electronic apparatus that sends the history data of the programs to the server of claim 1.

7. A server control method comprising the steps of:
receiving history data comprising a history of channel operations for switching programs;
setting a weight for each program based on a history of channel operations according to a first rule; and
storing the weight set for each program.

8. A non-transitory computer-readable medium storing a server control program that causes a server to execute controlling comprising:
receiving history data comprising a history of channel operations for switching programs;
setting a weight for each program based on a history of channel operations according to a first rule; and
storing the weight set for each program.
